(19) United States
(12) Patent Application Publication
(10) Pub. No.: US 2009/0257089 A1
(43) Pub. Date: Oct. 15, 2009

(54) Method and System for Managing Print Jobs for a Shared Printer

(75) Inventor: Ching-Wei Cheng, Keelung City (TW)

Correspondence Address: ROGER H. CHU, 19499 ERIC DRIVE, SARATOGA, CA, 95070, US

(73) Assignee: ACTION STAR ENTERPRISE CO., LTD., Sijhih, (TW)

(21) Appl. No.: 12/421,783

(22) Filed: Apr. 10, 2009

Related U.S. Application Data
(60) Provisional application No. 61/043,815, filed on Apr. 10, 2008.

(51) Int. Cl. G06F 3/12

(52) U.S. Cl. 358/1.15

(57) ABSTRACT

The present invention provides a method and system for managing print jobs for a shared printer. The system comprises a plurality of computers, a hub and a printer. Each of the computers coupled to the hub store a print control program for generating print jobs and sending the print jobs to the printer through the hub in response to print requests received from the computers automatically. The print control program generates an error printing control function when the printer fails to process the print jobs, and a temporary storage function when the printer is busy.

### CROSS REFERENCE TO RELATED APPLICATIONS

This application claims priority from a co-pending U.S. Provisional Patent Application Ser. No. 61/043,815 filed Apr. 10, 2008, the entire contents of which are incorporated herein by reference.

### BACKGROUND OF THE INVENTION

(a) Field of the Invention

The present invention relates to generally a printer shared by a plurality of computers, and more particularly, to a method and system for managing print jobs for a shared printer.

(b) Description of the Prior Art

Accordingly, by collecting print jobs from multiple computers to a commonly shared printer for output, a number of advantages are gained. For one, each computer no longer requires its own dedicated printer for the output of documents. This reduction in the number of printers required to support multiple computers may represent a significant financial savings for an organization. Additionally, the expense of maintaining and providing supplies for printers is reduced because the sharing of printer resources reduces the number of printers that need to be maintained by the organization.

The printer sharing control technique is a technique for allowing a plurality of computers connected through a hub (switch or adaptor) to share a printer on the hub. In general, the hub comprises several switches (for example, 4 switches) in response to several input ports (for example, 4 input ports). However, it wastes time that users need to switch the hub switches to the corresponding location themselves for processing print jobs.

The other method of printer sharing control technique is allowing a plurality of computers connected through a network to share a printer on the network. The printer is connected to a computer called a printer server which stores a program for effecting a printer sharing control. On the other hand, computers called clients each store an application for using the printer, i.e. a printer use program, for sending print requests. However, the program needs several setting up steps for processing print jobs normally. Users might not know how to set up the program that causes the users failure to use the printer. Moreover, in some cases, one user does take another user's print job, after becoming frustrated in looking for the missing job, must return to his or her computer and send another print job to the printer. This not only wastes the user's time and resources, but it is also an inefficient use of the printer resources as the print job must be printed a second time.

It is desirable, therefore, to provide a system for managing print jobs for a shared printer to allow users easy to use without complex setting steps and make sure the print jobs won't be missing.

### SUMMARY OF THE INVENTION

It is an object of the present invention to provide a system for managing print jobs for a shared printer to allow users easy to use without complex setting steps.

Another object of the present invention to provide a system for managing print jobs for a shared printer to make sure the print jobs won't be missed.

According to a preferred embodiment, the present invention provides a system for managing print jobs for a shared printer, the system comprising a plurality of computers, a hub and a printer; wherein each of the computers coupled to the hub store a print control program for generating print jobs and sending the print jobs to the printer through the hub in response to print requests received from the computers automatically; wherein the print control program generates an error printing control function when the printer fails to process the print jobs, and a temporary storage function when the printer is busy.

Additionally, there is provided a method for managing print jobs for a shared printer, the method comprising installing a print control program in a plurality of computers; providing print requests to the computers; generating print jobs according to the print requests and sending the print jobs to the printer; checking the printer's status and generating an error printing control function for warning when the printer's status is fail and generating a temporary storage function for temporary storing the print job when the printer's status is busy; and processing the print jobs; wherein the print control program checks if the printer's status busy or not again and again and the printer processes the print jobs until the printer's status is not busy.

### BRIEF DESCRIPTION OF THE DRAWINGS

FIG. 1 is a block diagram illustrating system for managing print jobs for a shared printer.

FIG. 2 is a flow chart illustrating method for managing print jobs for a shared printer.

### DETAILED DESCRIPTION OF THE PREFERRED EMBODIMENTS

When a printer is connected to a computer, for example via a Universal Serial Bus (USB), the printer provides its model name and serial number to the computer. The computer checks whether a logical port has been created for the printer based on the provided model name and serial number. If no logical port has been created, the computer creates one accordingly. Subsequently, the computer loads and assigns a printer driver to the created logical port for the printer. The present invention provides a system and method for managing print jobs for a shared printer with a print control program for checking whether a logical port has been created for the printer and the model name and serial number of the printer automatically. Moreover, the present invention also provides a printing environment to make sure the print jobs won't be missed.

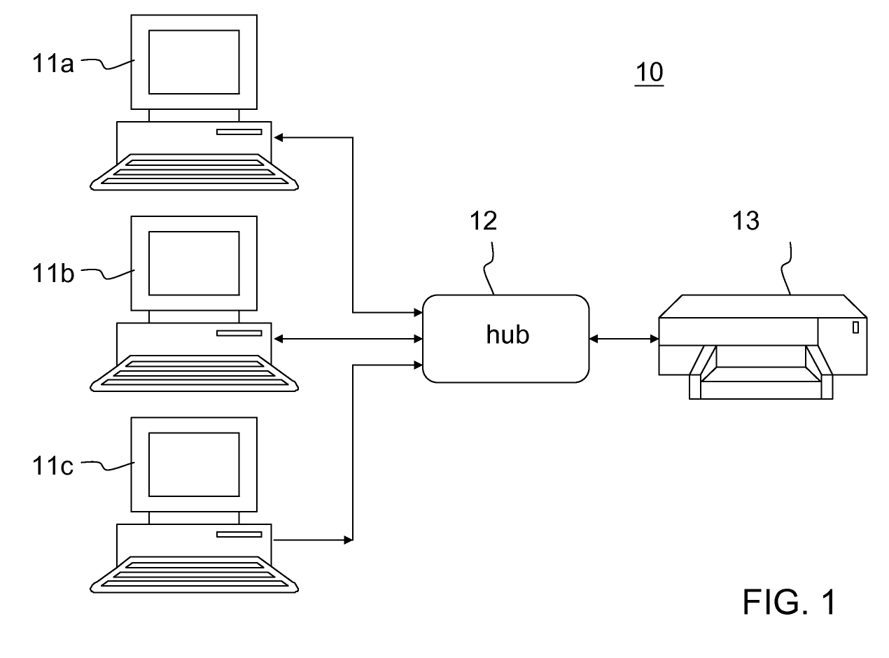

As shown in FIG. 1, the system 10 comprises a plurality of computers 11a˜11c, a hub 12 and a printer 13. The interfaces of the printer 13 and he hub 12 are USB (universal serial bus) or IEEE 1394 or other suitable interfaces used for transmitting between the computer 11a-11c, the hub 12 and the printer 13. Each of the computers 11a˜11c coupled to the hub 12 store a print control program for generating print jobs and sending the print jobs to the printer 13 through the hub 12 in response to print requests received from the computers 11a˜11c automatically. When the printer 13 fails to process the print jobs (for example, running out of papers, running out of printer ink or paper jammed, etc.), the print control program generates an error printing control function for warning. When the printer is busy (processing other printing jobs), the print control program generates a temporary storage function for temporary storing the print job for avoiding missing the print job. The print job is temporary storing in the computer or the printer's bult-in memory. Also, when the printer 13 fails to process the print jobs, the print control program generates a temporary storage function for temporary storing the print job for avoiding missing the print job and the print job is temporary storing in the computer or the printer's bult-in memory.

For example, when a first user operates the computer 11a to print, the print control program stored in the computer 11a generates a print job and sends the print jobs to the printer 13 through the hub 12 in response to the first user's print request received from the computer 11a automatically. If the printer 13 fails to process the print job due to running out of papers, running out of printer ink or paper jammed or other unexpected situation, the print control program generates an error printing control function for waning. After receiving the error printing control function, the first user knows that the printer 13 fails to process the print job, and then the first user will remove all the failure factors for operating the printer 13 normally.

If a second user operates the computer 11b to print while the printer 13 is processing the print job from the computer 11a, for the second user speaking, the printer is in busy. Therefore, the print control program of the computer 11b generates a temporary storage function for temporary storing the print job for avoiding missing the print job. The print job is temporary stored in the computer 11b or the printer's bult-in memory.

Moreover, the printer 13 further comprises a sorting unit (not shown) for ranking the priority of the print jobs from the computer 11a-11c. For example, if each print control program stored in the computer 11a-11c generates print jobs and sends the print jobs to the printer 13 through the hub 12 in turn while the printer 13 is processing other print jobs, the sorting unit of the printer 13 ranks the print jobs from the computer 11a-11c with a first-in-first-out concept. In the other words, after the printer 13 finishing the original print jobs, the print 13 follows to process the print job from the computer 11a according to the sorting unit, then processes the print job from the computer 11b-11c in turn according to the sorting unit.

Furthermore, after the printer 13 finishing the print job from the computer 11a, the print control program stored in the computer 11a generates a print completing message for reminding the user to get the documents printed by the printer 13. Thus, the period of the documents on the printer 13 will be reduced and the chance of other users catching sight of the documents will be also reduced.

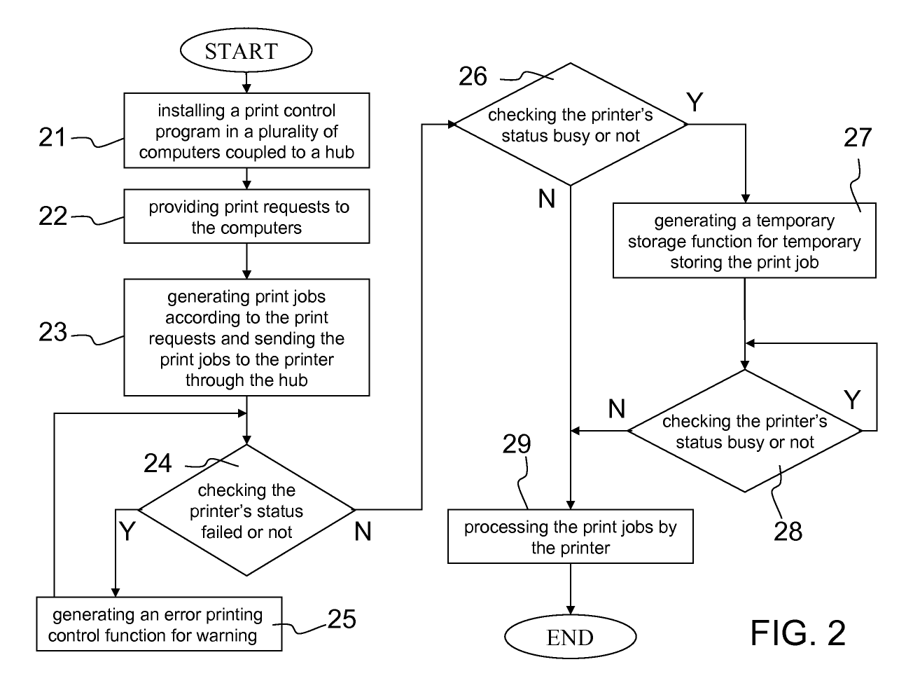

FIG. 2 shows a flow chart illustrating method for managing print jobs for a shared printer. At first, users need to install a print control program in a plurality of computers coupled to a hub (step 21). After installing the print control program, the print control program checks whether a logical port of the computer has been created for the printer and the model name and serial number of the printer automatically. Thus, it's easy for users to use without complex setting steps. Then the users providing print requests to the computers (step 22). The print control program generates print jobs according to the print requests from the user and sends the print jobs to the printer through the hub (step 23). After step 23, the print control program checks the printer's status failed or not (step 24). If the printer's status is fail (for example, running out of papers, running out of printer ink or paper jammed, etc.), the print control program generates an error printing control function for warning (step 25). User can clear up the fail status according to the error printing control function immediately. If the printer's status is normal, the print control program checks if the printer's status busy or not (step 26). If the printer's status is not busy, then the printer processes the print jobs (step 29). If the printer's status is busy, the print control program generates a temporary storage function for temporary storing the print job (step 27) for avoiding missing the print job. Meanwhile, the print job is temporary storing in the computer or the printer's bult-in memory. Then the print control program checks if the printer's status busy or not again and again (step 28) and the printer processes the print jobs (step 29) until the printer's status is not busy.

Moreover, the printer further comprises a sorting unit (not shown) for ranking the priority of the print jobs from each of the computers. If each print control program stored in each of the computers generates print jobs and sends the print jobs to the printer through the hub in turn while the printer is processing other print jobs, the sorting unit of the printer ranks the print jobs from each of the computers with a first-in-first-out concept. In the other words, after the printer finishing the original print jobs, the print follows to process the print job from one of the computers according to the sorting unit, then processes the print job from the other computer in turn according to the sorting unit.

Furthermore, after the printer finishing the print job from each of the computers, the print control program stored in the computer generates a print completing message to remind the user to get the documents printed by the printer. Thus, the period of the documents on the printer 13 will be reduced and the chance of other users catching sight of the documents will be also reduced.

Therefore, the printer sharing control technique of the present invention is not only easy to use, but also avoiding missing the print job for solving the aforementioned problems.

Having thus described a preferred embodiment of an system and method for managing print jobs for a shared printer and provides to allow users easy to use without complex setting steps and make sure the print jobs won't be missed, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

I claim:

1. A system for managing print jobs for a shared printer, the system comprising a plurality of computers, a hub and a printer; wherein each of the computers coupled to the hub store a print control program for generating print jobs and sending the print jobs to the printer through the hub in response to print requests received from the computers automatically; wherein the print control program generates an error printing control function when the printer fails to process the print jobs, and a temporary storage function for temporary storing the print job when the printer is busy.

2. The system as defined in claim 1, wherein the print control program checks model name and serial number of the printer automatically.

3. The system as defined in claim 1, wherein the print job is temporary stored in the computer or the printer's built-in memory.

4. The system as defined in claim 1, wherein the interfaces of the printer and he hub are USB or IEEE 1394.

5. The system as defined in claim 1, wherein the printer further comprises a sorting unit for ranking the priority of the print jobs from the computers.

6. The system as defined in claim 1, wherein the print control program stored in the computer generates a print completing message after the printer finishing the print job from the computer.

7. A method for managing print jobs for a shared printer, the method comprising: installing a print control program in a plurality of computers; providing print requests to the computers; generating print jobs according to the print requests and sending the print jobs to the printer; checking the printer's status and generating an error printing control function for warning when the printer's status is fail and generating a temporary storage function for temporary storing the print job when the printer's status is busy; and processing the print jobs; wherein the print control program checks if the printer's status busy or not again and again and the printer processes the print jobs until the printer's status is not busy.

8. The method as defined in claim 7, wherein the print control program further checks the model name and serial number of the printer automatically.

9. The method as defined in claim 7, wherein the print job is temporary stored in the computer or the printer's built-in memory.

10. The method as defined in claim 7, further comprising the step of ranking the priority of the print jobs from each of the computers.

11. The method as defined in claim 7, further comprising the step of generating a print completing message after the printer finishing the print job from the computer.
